(19) United States
(12) Patent Application Publication
(10) Pub. No.: US 2009/0212911 A1
(43) Pub. Date: Aug. 27, 2009

(54) RADIO FREQUENCY IDENTIFICATION DATA PROCESSING SYSTEM

(76) Inventors: Sang Cheol Min, Seoul (KR); Hee Seung Kim, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 11/913,051

(22) PCT Filed: Apr. 28, 2006
(86) PCT No.: PCT/KR06/01623

§ 371 Date: Jun. 23, 2008

Related U.S. Application Data
(60) Provisional application No. 60/676,218, filed on Apr. 29, 2005.

(51) Int. Cl. H04Q 5/22

(52) U.S. Cl. 340/10.1

(57) ABSTRACT

Provided is a method and device for processing RFID tag data. According to the method and device, tag data are read by an RFID reader, and server connection data recognized from the tag data are displayed on a display unit of the device. It is possible to directly receive additional data and additional services from a corresponding server by connecting to a system indicated by the displayed connection data.

### TECHNICAL FIELD

The present invention relates to a method and device for recognizing and processing radio frequency identification (RFID) data.

### BACKGROUND ART

The ISO and EPC standards define a reader protocol that supports connection of an RFID reader to a host through a network. In RFID systems, an RFID reader is mounted on a mobile phone or attached to the mobile phone in a dongle configuration. An RFID reader control unit of the mobile phone controls the RFID reader to write/read data to/from a tag.

In mobile phone environments, an RFID system is employed between a processor (e.g., MPU and MCU) of a mobile phone and an RFID reader chip installed in the mobile phone. Alternatively, a reader protocol is employed between a mobile phone and an RFID reader attached onto the mobile phone in a dongle configuration. When an RFID reader is attached onto a mobile phone in a dongle configuration, the RFID reader and the mobile phone are connected by an interface unit such as UART or USB.

### DISCLOSURE OF INVENTION

### Technical Problem

The present invention provides a method and device for processing RFID data, which makes it possible to obtain more various and abundant data using a user data area of a tag.

### Technical Solution

An object of the present invention is to provide a method and device for processing RFID tag data.

Another object of the present invention is to provide a method and device for processing RFID data, which makes it possible to obtain necessary additional data by writing server connection data to an RFID tag and connecting a mobile terminal including an RFID reader to a corresponding server.

To achieve these objects and other advantages and in accordance with the purpose of the invention, as embodied and broadly described herein, there is provided an RFID data processing method including: recognizing tag data; displaying the recognized tag data; and connecting to a system indicated by the displayed tag data.

In another aspect of the present invention, there is provided an RFID data processing method including: recognizing tag data; recognizing connection data of a user data area among the recognized tag data and displaying the recognized connection data; and connecting to a system according to the displayed connection data to access necessary data.

The connection data may be selected from a plurality of connection data.

The connection data may be position data for connection to a corresponding system.

The connection data may be URL-based server position data.

The connection data may be provided on the basis of an HTML.

The system may be connected through a wired or wireless network according to the connection data.

In a further another aspect of the present invention, there is provided an RFID data processing device including: a reader unit for recognizing tag data; a unit for extracting connection data from the recognized tag data and displaying the extracted data; and a unit for accessing a corresponding server according to the displayed connection data to receive necessary data.

The connection data may be written into a user data area of a tag.

The RFID data processing device may further include a unit for selecting one of a plurality of the connection data.

In a still further another aspect of the present invention, there is provided a mobile terminal including: an RFID reader for reading tag data; a controller for controlling an operation of displaying connection data written into a user data area among the tag data and an operation of connecting to a corresponding server; a display unit for displaying connection data processed by the controller; a user interface unit for selecting the displayed connection data and performing connection to the corresponding server; and a communication unit for accessing the corresponding server according to the selected connection data to receive necessary data.

It is to be understood that both the foregoing general description and the following detailed description of the present invention are exemplary and explanatory and are intended to provide further explanation of the invention as claimed.

### ADVANTAGEOUS EFFECTS

In an RFID system according to the present invention, data for connection to a server is written to a tag, and a mobile terminal including an RFID reader is connected to a corresponding server to directly access necessary data on the basis of the server connection data read from the tag by the RFID reader. Accordingly, the present invention can provide RFID system environments that make it possible to receive more various services and more abundant data from a related server on the basis of a tag.

### BRIEF DESCRIPTION OF THE DRAWINGS

FIGS. 1 and 2 illustrate the configurations of mobile RFID systems according to embodiments of the present invention.

FIGS. 3 and 4 illustrate examples of the structure of tag data according to embodiments of the present invention.

FIG. 5 is a block diagram of a mobile RFID terminal according to an embodiment of the present invention.

FIG. 6 is a flowchart illustrating an RFID data processing method according to an embodiment of the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

An RFID data processing system according to the present invention includes: an RFID reader configured to read data written into a tag; and a tag data processor configured to recognize and process the data read by the RFID reader. The tag data processor may be, for example, a mobile terminal. The mobile terminal may be, for example, a mobile phone. The RFID reader may be installed in the mobile terminal. Alternatively, the RFID reader may be connected through an interface unit to the mobile terminal in a dongle configuration.

In the following embodiments of the present invention, a mobile terminal (e.g., a mobile phone) with an RFID reader is taken as an example of a terminal with an RFID reader control unit.

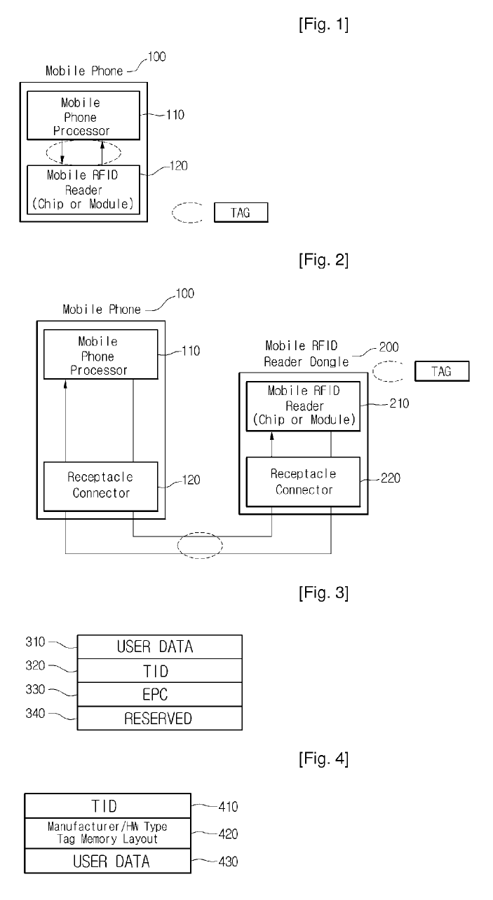

FIG. 1 illustrates a mobile RFID system configuration when a mobile RFID reader is installed in a mobile phone (which here is a mobile phone). FIG. 2 illustrates a mobile RFID system configuration when a mobile RFID reader is attached to the outside of a mobile phone (which here is a mobile phone) in a dongle configuration.

Referring to FIG. 1, a mobile phone 100 includes a mobile phone processor 110 and a chip-type or module-type mobile RFID reader 120. The mobile phone processor 110 controls the mobile RFID reader 120. Under the control of the mobile phone processor 110, the mobile RFID reader 120 writes/reads data to/from a tag. The tag data read by the mobile RFID reader 120 are transferred to the mobile phone processor 110. The mobile phone processor 110 decodes and recognizes the tag data. The mobile phone processor 110 stores the recognized tag data or provides the recognized tag data to a user using a display device.

Referring to FIG. 2, a mobile phone 100 includes a mobile phone processor 110 and a receptacle connector 120. A mobile RFID reader 210 is attached to the outside of the mobile phone 100 in a dongle configuration. The mobile RFID reader 210 is connected to the mobile phone 100 by receptacle connectors 120 and 220. The mobile phone processor 110 controls the mobile RFID reader 120 through the receptacle connectors 120 and 220. Under the control of the mobile phone processor 110, the mobile RFID reader 210 writes/reads data to/from a tag. The tag data read by the mobile RFID reader 210 are transferred to the mobile phone processor 110 through the receptacle connectors 120 and 220. The mobile phone processor 110 decodes and recognizes the tag data. The mobile phone processor 110 stores the recognized tag data or provides the recognized tag data to a user using a display device.

FIGS. 3 and 4 illustrate examples of the structure of tag data according to embodiments of the present invention. FIG. 3 illustrates an example of an EPG tag, and FIG. 4 illustrates an example of an ISO tag. An RFID tag includes a user data area in/from which user data can be freely stored/read. In the present invention, connection data are stored in the RFID tag. An RFID reader reads the connection data from the RFID tag and connects to a corresponding system (e.g., a server) indicated by the connection data. The connection to the server makes it possible to receive more various services and more abundant data from the server, which were unable to be provided from the tag.

In the embodiments of the present invention, connection data are written into the user data area of the RFID tag. The RFID reader reads the connection data written into the user data area. Alternatively, the RFID reader reads tag data to recognize the connection data written into the user data region.

For example, connection data are written into the user data area in the format of an HTML document. The HTML document format connection data written into the user data area is recognized from tag data read by the RFID reader, which is displayed on a display unit of a mobile terminal by using a corresponding viewer. A user selects the displayed connection data. According to the selection, the mobile terminal accesses a server, which is indicated by the connection data, through a wired or wireless network. This access to the server makes it possible to receive additional data and an available service from the server.

An example of the connection data is a position data of the server. Examples of the server position data are an URL and an IP address. One or more pieces of connection data may be written into the user data area, recognize and displayed. When the connection data are plural, a desired item is selected from displayed items and connection to the server is performed on the basis of the selected item.

Therefore, according to the embodiments of the present invention, it can be seen that the RFID tag can serve as an off-line hypertext in the user data area using the HTML. In general, an object ID (OID) or a tag ID (TID) is read from the RFID tag to identify the position of a corresponding server storing the related data, and the stored data is read by a PML scheme.

Referring to FIG. 3, a tag according to an embodiment of the present invention includes a user data area 310, a TID 320, an EPC 330, and a reserved area 340. As described above, connection data are stored in the user data area 310. The connection data may be stored in the format of an HTML document. That is, connection information necessary for connection to a specific server may be represented in the format of an HTML document. Accordingly, the RFID reader may read connection data from the user data area 310 (Alternatively, the RFID reader may read tag data 310-340 and recognize connection data written into the user data area 310 to perform connection to a corresponding server through a wired or wireless network.

Referring to FIG. 4, a tag according to another embodiment of the present invention includes a TID 410, a data area 420, and a user data area 430. The data area 420 is used to store data about manufacturers, hardware types, and tag memory layouts. The user data area 430 is assigned as an area to/from which users can freely store data. Also in this tag data structure, connection data are stored in the user data area 430. The connection data may be stored in the format of an HTML document. That is, connection information necessary for connection to a specific server may be represented in the format of an HTML document. Accordingly, the RFID reader may read connection data from the user data area 430. Alternatively, the RFID reader may read tag data 410-430 and recognize connection data written into the user data area 430 to perform connection to a corresponding server through a wired or wireless network.

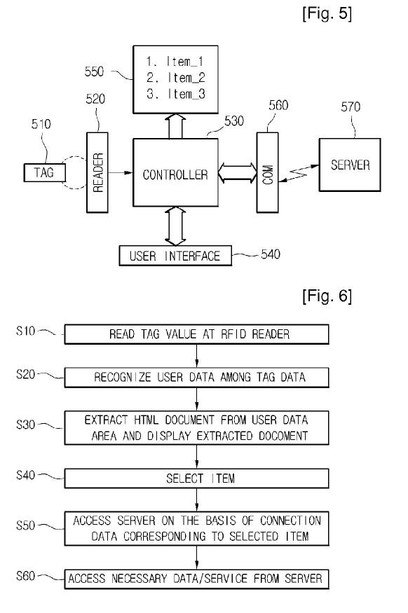

FIG. 5 is a block diagram of a mobile RFID terminal according to an embodiment of the present invention, in which an RFID data process is performed.

Referring to FIG. 5, a mobile RFID terminal includes: an RFID reader 520 reading data written into an RFID tag 510; a controller 530 processing the tag data read by the RFID reader 520; an user interface unit 540 for manipulating the terminal using the controller 530; a display unit 550 displaying the operation state and mode of the terminal, which are processed by the controller 530; and a communication unit 560 performing communication through a wired or wireless network under the control of the controller 530. A server 570 is connected through the communication unit 560 to the mobile RFID terminal to provide a service and data that are selected by a user. The controller 530 may be a processor installed in the mobile terminal. The user interface unit 540 may be a keypad. The display unit 550 may be an LCD. The communication unit 560 performs wired or wireless communication corresponding to a mobile communication network. The server 570 is connected according to position data on a network, which is indicated by connection data obtained from the tag 510.

The RFID tag 510 has a data storage area identical to that in FIG. 3 or 4. Data stored in the RFID tag 510 are read into the mobile terminal by the RFID reader 520.

Depending of the type of a tag data obtaining method selected by the user through the user interface unit 540, the RFID reader 520 reads all data of the tag or only data written into the user data area of the tag. The tag data read by the RFID reader 520 are transferred to the controller 530. The controller 530 reads the user data area of the tag and displays, on the display unit 550, connection data written into the user data area of the tag.

When the connection is written in the format of an HTML document, the controller 530 a corresponding document on the display unit 550 using an HTML viewer. The connection data may be singular or plural. FIG. 5 illustrates a case where three connection data are displayed in the format of an HTML document. These connection data are divided into a first item Item_1, a second item Item_2, and a third item Item_3. Each of the items represents each server connection data or connection data of different service items provided by the same server.

Depending on the connection data displayed on the display unit 550, the user selects a desired service item using the user interface unit 540. The controller 530 controls the communication unit 560 according to the connection data indicated by the selected service item. That is, the controller 530 commands the communication unit 560 to access the server 570 corresponding to the position on the network indicated by the connection data.

In response to the command, the communication unit 560 attempts to access the corresponding server 570 through a communication network. Since the mobile terminal is a mobile phone, it attempts to access the corresponding server 570 through a mobile communication network. When the connection to the corresponding server 570 is successful, the related contents are displayed on the display unit 550. As a result, the user can access, through the display unit 550, a variety of additional data and services provided by the corresponding server 570.

For example, let's assume that a tag is attached to a poster for movie advertisement and position data about an Internet server of a corresponding movie theater are stored in the user data area of the tag. Since the Internet server position data of the movie theater is contained in the user data area read by the RFID reader 520, it is displayed on the display unit 550. When the user commands, through the user interface unit 540, the corresponding server to be accessed, the controller 530 controls the communication unit 560 to access the corresponding server 570 through the mobile communication network. Accordingly, the data and services provided from the server 570 are received through the communication unit 560 and are displayed on the display unit 550. Therefore, the user can access and obtain more abundant and various data from the tag of the movie advertisement.

As another example, let's assume that a tag is attached to a poster for movie advertisement, and Internet server position data Item_1 of a corresponding movie theater, an Web site address Item_2 for introducing the corresponding movie, and a reservation service item Item_3 for viewing a movie are stored in the user data area of the tag. In this case, the user selects one of the items through the user interface unit 540. When desires to access a movie theater, the user selects the first item Item_1. When desires to obtain a variety of addition information about a movie, the user selects the second item Item_2. When desires to reserve viewing of a movie online, the user selects the third item Item_3. When the first item Item_1 is selected, the Internet server of the corresponding movie theater is accessed. When the second item Item_2 is selected, the Web sit server providing more abundant and various data about the movie is accessed. When the third item Item_3 is selected, a corresponding server providing an on-line movie reservation service is accessed.

FIG. 6 is a flowchart illustrating an RFID data processing method according to an embodiment of the present invention.

According to the RFID data processing method illustrated in FIG. 6, the RFID reader reads the value of a tag attached to a given product to display an HTML document of the user data area of the tag in a viewer. Accordingly, the user can directly access a desired service through a link, like a Web document.

Referring to FIG. 6, in operation S10, the RFID reader 520 reads data from the tag 510. This operation may be performed automatically, or may be performed when the user gives a tag read command through the user interface unit 540.

In operation S20, the controller 530 recognizes data that are written into a specific area (i.e., the user data area) of the tag. In the embodiment of the present invention, since server connection data are stored in the user data area in the format of an HTML document, an HTML document written in the user data area is recognized.

In operation S30, the HTML document in the user data area is extracted and the extracted HTML document is displayed on the display unit 550 through a viewer. The HTML document displayed on the display unit 550 must has at least one corresponding server connection data. As described with reference to FIG. 5, when the respective HTML document formats corresponding to a plurality of connection data are supported, operation S40 is performed to select one of the items. On the other hand, when only one connection data is supported, operation S40 is omitted.

In operation S40, when a plurality of connection data is provided, an item desired by the user is selected among the provided connection data.

In operation S50, on the basis of the connection data corresponding to the selected item, the controller 530 controls the communication unit 560 to access the corresponding server 570. The server 570 is connected through a wired or wireless communication network, and data for the connection to the server is position data on the network. The position data may be an URL or an IP address of the server.

When the connection to the server is successful, data provided from the server 570 are received through the communication unit 560. The received data are processed by the general data communication technology such as a decoding scheme and the resulting data are displayed on the display unit 550.

In operation S60, necessary data or services are directly accessed from the server.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The present invention is applied to an RFID system. It is possible to additionally obtain more abundant and various data through the related server using the data read from the tag. Also, it is possible to directly access the desired server by the RFID tag data, using the mobile terminal and the RFID reader, which is installed in the mobile terminal or attached to the mobile terminal in a dongle configuration.

1. A data processing method comprising:
recognizing tag data;
displaying the recognized tag data; and
connecting to a system indicated by the displayed tag data.

2. The data processing method according to claim 1, wherein the connection data is written into a user data area of a tag.

3. The data processing method according to claim 1, wherein the connection data are selected from a plurality of connection data.

4. The data processing method according to claim 1, wherein the connection data are position data for connection to a corresponding system.

5. The data processing method according to claim 1, wherein the connection data are URL-based server position data.

6. The data processing method according to claim 1, wherein the connection data are provided on the basis of an HTML.

7. The data processing method according to claim 1, wherein the system is connected through a wired or wireless network according to the connection data.

8. A data processing method comprising:
recognizing tag data;
recognizing connection data of a user data area among the recognized tag data and displaying the recognized connection data; and
connecting to a system according to the displayed connection data to access necessary data.

9. The data processing method according to claim 8, wherein the connection data are selected from a plurality of connection data.

10. The data processing method according to claim 8, wherein the connection data are position data for connection to a corresponding system.

11. The data processing method according to claim 8, wherein the connection data are URL-based server position data.

12. The data processing method according to claim 8, wherein the connection data are provided on the basis of an HTML.

13. The data processing method according to claim 8, wherein the system is connected through a wired or wireless network according to the connection data.

14. A data processing device comprising:
a reader unit for recognizing tag data;
a unit for extracting connection data from the recognized tag data and displaying the extracted data; and
a unit for accessing a corresponding server according to the displayed connection data to receive necessary data.

15. The data processing device according to claim 14, wherein the connection data is written into a user data area of a tag.

16. The data processing device according to claim 14, further comprising a unit for selecting one of a plurality of the connection data.

17. A mobile terminal comprising:
an RFID reader for reading tag data;
a controller for controlling an operation of displaying connection data written into a user data area among the tag data and an operation of connecting to a corresponding server;
a display unit for displaying connection data processed by the controller;
a user interface unit for selecting the displayed connection data and performing connection to the corresponding server; and
a communication unit for accessing the corresponding server according to the selected connection data to receive necessary data.

18. The mobile terminal according to claim 17, wherein the connection data are position data for connection to a corresponding system.

19. The mobile terminal according to claim 17, wherein the connection data are URL-based server position data.

20. The mobile terminal according to claim 17, wherein the connection data are provided on the basis of an HTML.
